(19) United States
(12) Patent Application Publication
(10) Pub. No.: US 2026/0321062 A1
(43) Pub. Date: Oct. 15, 2026

(54) CONTACTLESS ENTITY VEIN RECOGNITION AND/OR IDENTIFICATION METHOD AND DEVICE

(71) Applicant: GLOBAL ID SA, Lausanne (CH)

(72) Inventors: Lambert SONNA MOMO, Romont (FR); David GEISSBÜHLER, Lausanne (CH); Sushil BHATTACHARJEE, Renens (CH); Guillaume CLIVAZ, Miege (CH); Ketan KOTWAL, Martigny (CH); Sébastien MARCEL, Martigny (CH)

(21) Appl. No.: 19/178,421

(22) Filed: Apr. 14, 2025

(51) Int. Cl. G06V 40/40; G06V 10/141; G06V 10/26; G06V 10/82; G06V 40/12; G06V 40/13; G06V 40/145

(52) U.S. Cl. CPC G06V 40/45; G06V 10/141; G06V 10/26; G06V 10/82; G06V 40/1312; G06V 40/1365; G06V 40/1388; G06V 40/145

(57) ABSTRACT

The present invention concerns a contactless entity vein recognition and/or identification method, comprising:
presenting an entity to an entity vein recognition and/or identification device, wherein the interaction between the entity and the device occurs contactlessly, wherein the entity is at least one finger, a hand's palm, a hand and/or of a wrist;
capturing a first set of images of supposed subcutaneous veins of an inspecting portion of the entity from at least one NIR camera;
capturing a second set of images of supposed subcutaneous veins of the inspecting from the NIR camera,
estimating a likelihood that said supposed subcutaneous veins correspond to solid veins of the inspecting portion by using the first set of images;
performing a photometric-stereo reconstruction of the inspecting portion by using the second set of images;
deciding, based on said likelihood and on the photometric-stereo reconstruction, whether the entity is a genuine body part or a spoof.

This method allows contactless VR and PAD with quality and/or accuracy higher than known methods.

The present invention concerns also the corresponding device.

### TECHNICAL DOMAIN

The present invention concerns contactless entity vein recognition and/or identification method and device. In this context, the term “entity vein” indicates the vein(s) of (at least one) finger, of the hand's palm, of the hand and/or of the wrist.

### RELATED ART

Vascular biometrics offers several advantages over biometrics, such as high accuracy, robustness to variations in ambient illumination and robustness to spoofs or presentation attacks (PA).

In the context of ID/recognition of users, a spoof is a falsified presentation of biometric pattern that is/was presented to a biometric vascular device, for forcing the device to identify and/or recognize another (absent and/or unwilling) user.

Finger-vein (FV) devices are the most common type of vascular-biometrics devices.

Most current FV devices commercially available use transmissive near-infrared (NIR) illumination, wherein a camera captures the light passing through the finger.

In this context, a NIR illumination has a wavelength comprised in the range 0.78 μm-3 μm.

Currently available FV devices mostly rely on contact-imaging, i.e. they require that the user's finger is in direct contact with the device, i.e. it touches the device.

The finger is placed between a light-source and a camera. The NIR light is scattered in the finger-tissue and absorbed by oxygenated haemoglobin in the blood vessels. This design has the advantage that the device captures only light that has travelled through the finger and is robust to interference due to external light.

However, direct contact with a biometric device can raise concerns from a hygiene point of view, which can be critical in environments such as hospitals, retail outlets, or any other environment where the transmission of pathogens across surfaces should be mitigated.

Some devices require the finger to be placed in an enclosure. This can be uncomfortable for the user.

Reflection-based vascular biometric devices, on the other hand, can be made contactless as by their geometry the light-source is facing the same direction as the sensor. This family of sensors takes advantage of the penetration depth, typically a few millimetres, of NIR light into the skin tissue which enables capture of the shallow vein network. Unfortunately, this technique yields an output signal of a much lower quality.

Moreover, unlike for face-biometrics, publicly available FV datasets are not large enough to train a convolutional neural network (CNN) from scratch.

### Short Disclosure of the Invention

An aim of the present invention is the provision of a contactless entity vein recognition and/or identification method and/or device, which overcomes the shortcomings and limitations of the state of the art.

Another aim of the invention is the provision of a contactless entity vein recognition and/or identification method and/or device, yielding an output signal of a higher quality than known methods and devices.

Another aim of the invention is the provision of a contactless entity vein recognition and/or identification method and/or device, allowing contactless VR and PAD with an accuracy higher than known methods and devices.

According to the invention, these aims are attained by the object of the attached claims, and especially by the contactless entity vein recognition and/or identification method according to claim 1 and by the contactless entity vein recognition and/or identification device according to claim 14, whereas dependent claims deal with alternative and preferred embodiments of the invention.

The contactless entity vein recognition and/or identification method according to the invention comprises:
presenting an entity to an entity vein recognition and/or identification device, wherein the interaction between the entity and the device occurs contactlessly, wherein the entity is at least one finger, a hand's palm, a hand and/or of a wrist;
capturing a first set of images of supposed subcutaneous veins of an inspecting portion of the entity from at least one NIR camera;
capturing a second set of images of supposed subcutaneous veins of the inspecting from the NIR camera,
estimating a likelihood that said supposed subcutaneous veins correspond to solid veins of the inspecting portion by using the first set of images;
performing a photometric-stereo reconstruction of the inspecting portion by using the second set of images;
deciding, based on said likelihood and on the photometric-stereo reconstruction, whether the entity is a genuine body part or a spoof.

The device according to the invention allows a user to be recognized and/or identified, i.e. it allows detecting and acknowledging someone or something and/or determining who someone is among a group. It can also be used for authentication, i.e. it can allow verifying that someone is who he/she claims to be.

With respect to what is known in the art, the invention provides the advantage that it exploits also a photometric-stereo reconstruction of the inspecting portion. The photometric-stereo reconstruction, combined with the other images from the NIR camera, allows to obtain a higher quality than known methods and devices and therefore to improve its accuracy.

Unlike existing FV devices that capture vascular data from only one finger at a time, the device according to the invention can also image many (e.g. four) fingers of a hand simultaneously. This enables to implement contactless multi-finger vein recognition, which is not possible using known FV devices.

In one embodiment, the first set of images of supposed subcutaneous veins of an inspecting portion of the entity are taken by only one NIR camera.

In one embodiment, performing photometric-stereo reconstruction comprises capturing the second set of images under a controlled illumination-sequence, wherein each image is illuminated from a different angle.

In one embodiment, the second set of images comprises at least two images, for example four images. In one embodiment, two images are sufficient to reconstruct a 3D surface of the entity in one direction. For example, two images allow to reconstruct the surface-normals of the entity e.g. along the x-axis (e.g. the axis between two illuminators), but not along the y-axis (e.g. the axis orthogonal to the illumination-axis).

In one embodiment, for the photometric-stereo reconstruction, one NIR camera is used. In one embodiment, this camera is a NIR camera at 850 nm.

In one embodiment, the entity is illuminated in a specific pattern, i.e. with a specific illumination sequence, for the photometric-stereo reconstruction.

In one embodiment, the first set of images and the second set of images are each captured by two NIR cameras.

In one embodiment, the entity is illuminated at 850 nm and at 950 nm.

In one embodiment, the method comprises capturing a third set of images by a colour camera with white illumination and using also the third set of images for deciding whether the entity is a genuine body part or a spoof.

In one embodiment, the method comprises performing a Stereo Vision reconstruction by using at least one NIR camera and a laser dot projector, for reconstructing the shape, texture and/or reflectivity map, throughout various wavelengths, of the entity.

In one embodiment, the method comprises capturing vein-images of multiple fingers simultaneously and combining information from several fingers, to increase the recognition and/or identification accuracy.

In one embodiment, the method comprises creating a FV template from a FV sample.

In one embodiment, creating a FV template from a FV sample comprises:
presenting an input image;
segmenting the entity out from the input image,
applying a normalization step to each individual finger-image, for rotating the finger-image to align the longitudinal axis of the finger to the vertical axis as best as possible,
enhancing the vascular structures in the input normalized finger image,
extracting vascular feature(s),
performing a finger-vein matching step.

In one embodiment, the segmenting step is done in a NIR domain.

In one embodiment, creating a FV template from a FV sample comprises using a pre-trained autoencoder to enhance the vascular structures in the input normalized finger image.

In one embodiment, extracting vascular feature(s) comprises using a Maximum-Curvature feature-map extracted for a single finger.

In one embodiment, the method comprises a PAD method, the PAD method comprising:
providing an input sample;
generating a surface-normal map, wherein each map comprises surface-normal vectors computed for each pixel-position;
detecting entity's regions;
performing a feature extraction so as to generate feature-vectors;
classifying feature-vectors;
performing a PAD decision.

In one embodiment, Gaussian Mixture Models (GMM) is used to classify the feature-vectors.

The present invention concerns also a contactless finger vein recognition and/or identification device, comprising:
a top surface, wherein the interaction between the entity and the top surface occurs contactlessly, wherein the entity is at least one finger, a hand's palm, a hand and/or of a wrist;
at least one NIR camera for capturing a first set of images of supposed subcutaneous veins of an inspecting portion of the entity, and for capturing a second set of images of supposed subcutaneous veins of the inspecting from the NIR camera,
a first computing module for estimating a likelihood that said supposed subcutaneous veins correspond to solid veins of the inspecting portion by using the first set of images;
a second computing module for performing a photometric-stereo reconstruction of the inspecting portion by using the second set of images;
a third computing module for deciding, based on said likelihood and on the photometric-stereo reconstruction, whether the entity is a genuine body part or a spoof.

In one embodiment, the device comprises three cameras.

In one embodiment, the three cameras comprise a colour camera, e.g. an RGB camera, and two NIR cameras.

In one embodiment, the cameras are arranged in a substantially triangular shape.

In one embodiment, each of the cameras has an orientation substantially perpendicular to the top surface.

In one embodiment, the device comprises N illumination banks of M modules, each module comprising R light-sources.

In one embodiment, the light-sources are LEDs.

In one embodiment, the device comprises at least one illumination bank on one side and at least one illumination bank on the opposite side relative to the central camera(s).

In one embodiment, each illumination bank is tilted or can be tilted around an axis.

In one embodiment, the device comprises in its internal volume one or more computing modules, an optional adapter module between the computing module(s) and each camera, a controller module, connected to each camera, the light sources, laser divers(s), an image sensor as a CCD or CMOS sensor, comprising an array of photodiodes or other types of detectors working together to capture images, and/or possible MEMS mirror(s) with possible driver(s) as high-voltage (HV) driver(s).

In one embodiment, the first, second and/or third computing module are the same computing module.

In one embodiment, the device comprises each of the first, second and/or third computing module is or comprises a machine-learning module.

The device according to the invention and/or the method according to the invention, comprising their embodiments, are suitable for environments such as hospitals, retail outlets (for example and in a non-limitative way for payment), or any other environment where the transmission of pathogens across surfaces should be mitigated. They are specifically suitable for the health domain, for example for securing physical and logical access in the health domain. They are also suitable for the automotive domain, for securing physical and logical access in the automotive domain. They are in general suitable for securing physical and logical access for individuals.

According to an independent aspect of the invention, the invention relates also to a dataset for training a machine-learning module of the device according to the invention, for FV Authentication (FVA) or PDA.

In one embodiment, the dataset comprises images printed on different papers (e.g. mate paper, glossy paper, e.g.). In one embodiment, the dataset comprises images printed by different printers (e.g. laser printer, inject printer, etc.). In one embodiment, the dataset comprises images printed on different support (e.g. paper, plastic, etc.).

### SHORT DESCRIPTION OF THE DRAWINGS

Exemplar embodiments of the invention are disclosed in the description and illustrated by the drawings in which:

FIG. 1A illustrates a perspective view of a contactless entity vein recognition and/or identification device according to one embodiment of the invention.

FIG. 1B illustrates a top view of the contactless entity vein recognition and/or identification device of FIG. 1A.

FIG. 1C illustrates a lateral view of the contactless entity vein recognition and/or identification device of FIG. 1A.

FIG. 2 illustrates a top view of three cameras of a contactless entity vein recognition and/or identification device according to one embodiment of the invention.

FIG. 3 illustrates schematically a top view of a (left) hand with the capture area of each camera of FIG. 2.

FIG. 4 illustrates schematically the connectivity diagram for the different modules of a contactless entity vein recognition and/or identification device according to one embodiment of the invention.

FIG. 5 shows an exemplary embodiment of a biometric vascular recognition and/or identification method for recognizing and/or identifying an individual based on his vascular biometric of at least one finger.

FIG. 6 shows a flowchart of the FV template creation process from a FV sample according to one embodiment of the invention.

FIGS. 7A to 7D show an example result of the vein-enhancement (FIG. 7A: extracted finger image; FIG. 7B: normalized finger-image; FIG. 7C: vein-enhanced finger-image; FIG. 7D: MC-feature-map extracted from FIG. 7C).

FIG. 8 shows a flowchart of proposed FV PAD method according to one embodiment of the invention.

FIGS. 9A to 9C show finger-vein data captured in various channels using the device according to one embodiment of the invention (FIG. 9A: fingers illuminated under 850 nm; FIG. 9B: fingers illuminated under 950 nm; FIG. 9C: pseudo-colour map showing the 3D surface-normals reconstructed from the photometric stereo data).

FIGS. 10A to 10D show the same finger-vein data as captured under a sequence of four different illumination for PS.

### EXAMPLES OF EMBODIMENTS OF THE PRESENT INVENTION

In the following description provided by way of example, reference will be made, for the sake of simplicity, to at least one finger of a hand as an entity. However, it should be understood that the invention is not limited to such an embodiment, but also includes other entities, as the palm or the wrist.

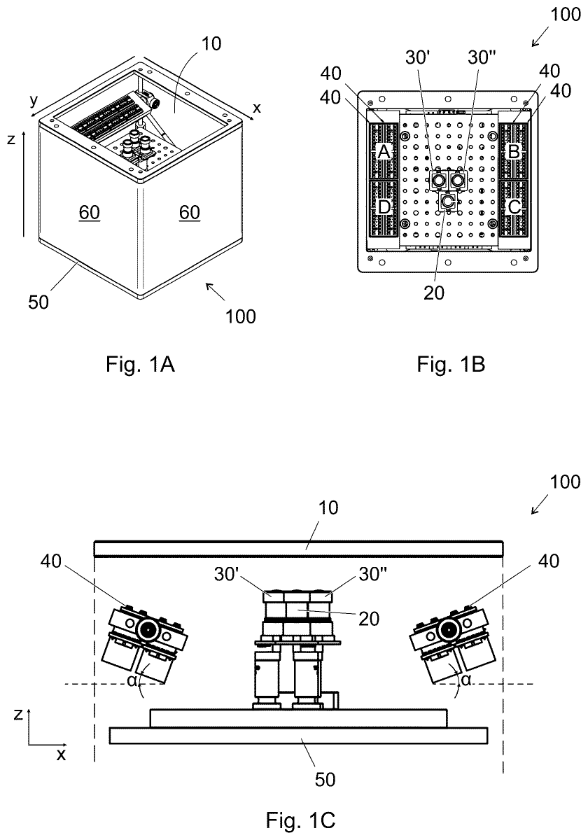

FIG. 1A illustrates a perspective view of a contactless entity vein recognition and/or identification device 100 (also referred to as “device 100” in the following) according to one embodiment of the invention. In one embodiment, it has a substantially cubic shape. However, it could have other shapes, as a parallelepipedal shape.

In one embodiment, the device 100 is portable, i.e. it is compact, lightweight, and designed for easy transport and use. In one embodiment, it does not require a fixed installation or external power sources. In one embodiment, it has a small footprint, e.g. similar or equal to 21×21×21 cm³.

In one embodiment, the contactless entity vein recognition and/or identification device 100 has a base surface 50, lateral surfaces 60 (e.g. four lateral surfaces, as in FIG. 1A) and a top surface 10.

In one embodiment, the top surface 10 is transparent.

The user must position his finger or his hand substantially parallel to the top surface 10 of the contactless entity vein recognition and/or identification device 100 without touching it, maintaining a distance from the top surface 10 of approximately 1 cm to 20 cm.

The top surface 10, the lateral surfaces 60 and the base surface 50 define an internal volume arranged for hosting the different components of the device 100.

FIG. 1B illustrates a top view of the device 100 of FIG. 1A. In this embodiment, the device 100 comprises three cameras, i.e. a colour camera 20, e.g. an RGB camera, and two NIR cameras 30′ and 30″.

In one preferred embodiment, each of the NIR cameras 30′ and 30″ is arranged for multi-spectral illumination for vein recognition (VR). In one preferred embodiment a first NIR camera (30′ or 30″) is arranged for VR at 850 nm and a second NIR camera (30″ respectively 30′) is arranged for VR at 950 nm.

In one preferred embodiment, the colour camera 20 is used with white illumination for surface features and PAD.

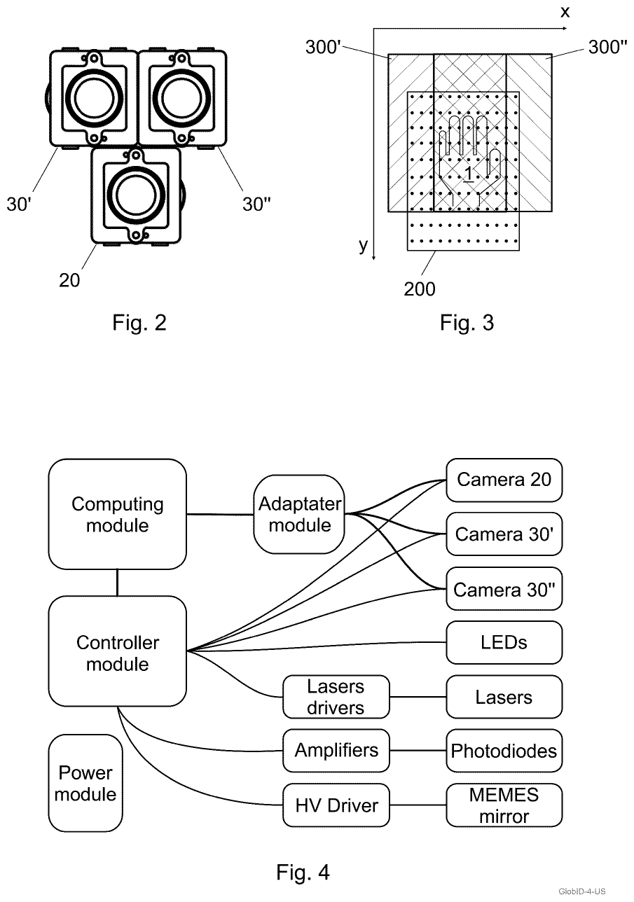

In one embodiment, the cameras 20, 30′ and 30″ are arranged in a substantially triangular shape, as better visible in FIG. 2. In one embodiment, the cameras 30′ and 30″ are aligned along a first direction substantially parallel to the x axis of FIG. 1A, and the camera 20 is placed on another axis substantially parallel to the x axis.

In one embodiment, the cameras 20, 30′ and 30″ are in a substantially central position in a plane substantially parallel to the plane xy.

In one preferred embodiment, each of the cameras 20, 30′ and 30″ has an orientation substantially perpendicular to the top surface 10 (i.e. along the z direction).

In one embodiment, the device 100 comprises also N illumination banks 40 of M (interchangeable) modules, each module comprising R (surface mounted) light-sources. In one preferred embodiment, the light-sources are LEDs. In one preferred embodiment, N=4, M=4 and R=16.

In one embodiment, the light from the light-source(s) is polarized.

In one embodiment, the device 100 comprises at least one illumination bank 40 on one side and at least one illumination bank 40 on the opposite side relative to the central cameras 20, 30′ and 30″.

As illustrated in particular in FIG. 1C, each illumination bank 40 is tilted or can be tilted around an axis substantially parallel to the y axis.

In one embodiment, the light intensity value is settable/variable for each light source (LED).

In one embodiment, the LEDs banks 40 can (also) be adjusted linearly along the z-axis. In order to find the best vertical position, angle and individual LED intensity values, a ray-tracing algorithm can be executed in the computing module, so as to predict those values. A manual optimization in situ could be performed as well.

In one embodiment, the absolute value of the inclination or tilting angle α with regard to the x direction in the plane xz is the same for the opposite illumination banks 40. In one embodiment, the tilting angle α belongs to the range 0°-80°, e.g. 20°-60°. In one embodiment, the tilting angle α has opposite signs for the opposite illumination banks 40, so that their light converges on the hand 1.

In one embodiment, each of the LED can be addressed individually, in both current and/or Pulse Width Modulation (PWM).

In one embodiment, the LEDs are powered by a dedicated DCDC Power Supply Unit (PSU).

In one embodiment, the LEDS can be switched and switching all LEDs (e.g. 256 LEDs) can take approximately 1 ms.

FIG. 3 illustrates schematically a top view of a (left) hand 1 with the capture areas 200, 300′ and 300″ of each camera 20, 30′ respectively 30″. The capture areas 200, 300′ and 300″ overlap, and the overlapping area covers the inspection portion of the entity.

FIG. 4 illustrates schematically the connectivity diagram for possible modules of the device 100, according to one embodiment of the invention.

In one embodiment, the device 100 comprises (preferably) in its internal volume one or more computing modules, an optional adapter module between the computing module(s) and each camera, a controller module, connected to each camera, the light sources (as LEDs and/or lasers), laser divers(s) (if laser(s) are present), an image sensor as a CCD or CMOS sensor, comprising an array of photodiodes or other types of detectors working together to capture images, and/or possible MEMS mirror(s) with possible driver(s) as high-voltage (HV) driver(s).

In one embodiment, the device 100 comprises also (miniaturized) optic element, like (miniaturized) lens(es).

In one embodiment, the image sensor is a CMOS sensor with good sensitivity in the NIR domain, e.g. capable of capturing NIR light. In one embodiment, the sensor has a global shutter allowing for accurate synchronization, if Stereo Vision is performed.

In one embodiment, the laser drivers are capable of driving lasers in both optical output power (APC) or constant current (ACC) modes.

In one embodiment, the controller module allows to control cameras' triggering in real-time, LEDs dimming and lasers switching.

In one embodiment, since the use of diode lasers in the NIR range is a safety concern as these wavelengths can reach the cornea and there is no blinking reflex as the light is largely invisible, laser dot projectors are used which project points of light (e.g. 30 k points) with a determined FoV (e.g. 67.7×53.4 degrees).

In embodiment, the power per ray of diode lasers is too low to cause any eye damage by itself, e.g. it is of the order of 3 W.

Additional safety measures can be implemented in order to protect the user, e.g. by closely monitoring laser power draw, by orienting the lasers so they are not directed in the user's eyes, by taking regular measurement of the optical output and/or by training the user to the specifics of the system.

In one embodiment, the device 100 is modular, i.e. it comprises different modules or components that can be easily placed or removed from the device 100. For example, the cameras and/or optical components can be mounted on an optical breadboard to allow re-positioning and extension.

In one embodiment, the device 100 comprises an enclosure made of two plates (e.g. aluminium plates) connected by (four) stainless rods along which components can slide.

In one embodiment, the device 100 is arranged to cooperate with a screen, a keyboard and/or a mouse and can be used like a regular computer.

In one embodiment, the computing module is or comprises a machine-learning module. In this context, the expression “machine-learning module” indicates a module which needs to be trained in order to learn i.e. to progressively improve a performance on a specific task.

The machine-learning module in a preferred embodiment is a neural network module, i.e. a module comprising a network of elements called neurons. Each neuron receives input and produces an output depending on that input and an “activation function”. The output of certain neurons is connected to the input of other neurons, thereby forming a weighted network. Weights can be modified by a process called learning which is governed by a learning or training function.

Although the neural network module is a preferred implementation of the machine-learning module, the device 100 is not limited to the use of a neural network module only, but could comprise other types of machine-learning modules, e.g. and in a non-limiting way machine-learning modules arranged to implement at least one of the following machine-learning algorithms:
decision trees, association rule learning, deep learning, inductive logic programming, support vector machines, clustering, Bayesian networks, reinforcement learning, representation learning, similarity and metric learning, sparse dictionary learning, genetic algorithms, rule-based machine-learning, learning classifier systems.

In one embodiment, the neural network module is a deep neural network module, e.g. it comprises multiple hidden layers between the input and output layers, e.g. at least three layers.

In one embodiment, the device 100 is autonomous, i.e. it can operate independently without needing an external power source, typically using an internal power supply module, like a battery or energy harvesting element.

In one embodiment, when relative LEDs intensities and bank positions are set, the absolute intensity of the illumination, integration time and camera sensor gain are setup to achieve the best possible performances.

In one embodiment, the capture frame rate is fixed at 50 Hz which leaves 20 ms per frame to which should be subtracted the time for switching on and off the LEDs banks 40 (e.g., 2 ms-3 ms) as well as the sensor time to recover the image frame. In one embodiment, the maximum integration time is around 5 ms.

According to the invention, a photometric-stereo (PS) reconstruction of the inspecting portion of the user is performed.

This allows to improve the device 100 accuracy, and it is specifically used for detecting spoofs.

In particular, each of the NIR cameras 30′, 30″ records vascular data and each NIR camera also records data for PS reconstruction of the target-surface of the inspecting portion, by capturing a set of images under a controlled illumination-sequence.

The PS reconstruction allows to obtain fine grained depth resolution and texture from a set of images illuminated from different angles.

In particular, a second set of images, e.g. four images taken with illumination from the LEDs banks respectively, e.g. taken with illumination from each corner of the LEDs banks respectively, is used to extract the depth for the PS.

In one embodiment, the N LED banks, when fired in the sequence, illuminate the inspecting portion from different angles. The resulting set of N images can be used to recover the surface-normal map of the hand. This PS reconstruction produces a dense surface-normal map. It also produces an albedo image of the entity being imaged.

In one embodiment, the surface's normals of the illuminated finger are estimated by solving the least-square solution for the equation:

I=L·N (1)

with I the intensities observed in the images for each pixel, L the normalized vectors for each light sources and N the normal surfaces.

In one embodiment, several assumptions are assumed to simplify the problem:
The light vectors are assumed constant overall the image, such as emitted from infinitely distant isotropic sources,
The hand skin is considered with a Lambertian reflectance model, without specular reflection, and/or
The hand surface is assumed smooth.

A flat-field calibration can also be performed to compensate the inverse square law of light propagation, by using a flat reference with a constant albedo. This method can rely on the assumption that the hand is almost planar and/or its surface not deviating much from that of the reference plane.

In other words, the method according to the invention relies on a dense surface-normal map from the PS data recorded by each NIR camera.

In one embodiment, for FVA, FV images recorded by the two NIR cameras under 850 nm and 950 nm illumination are used. In one embodiment, there are images (e.g. three images) captured under NIR-850 illumination for each of the two (left, right) NIR cameras, and similarly, three images captured under NIR-950 illumination. There are also additional images (e.g. four images) captured specifically for PS reconstruction.

In other words, the device 100 is arranged also collects a sequence of supplementary images (e.g. four images) where the presented entity is illuminated from a different angle for every image. PS reconstruction may be applied to this sequence of images to compute a surface-normal map.

In one embodiment, each image of the supplementary images (i.e. the second set of images) is taken by using a specific illumination. In other words, the second set of images are taken under a specific illumination sequence.

In one embodiment, a first image of this second set of images is taken by illuminating the entity with a first illumination group (reference A in FIG. 1B), the group being or belonging to an illumination bank, for example the group on a first side of the cameras (the left side in FIG. 1B), in the top part of the device. In one embodiment, a second image of this second set of images is taken by illuminating the entity with a second illumination group (reference B in FIG. 1B), for example the group on a second side of the cameras (the right side in FIG. 1B), in the top part of the device. In one embodiment, a third image of this second set of images is taken by illuminating the entity with a third illumination group (reference C in FIG. 1B), for example the group on the second side of the cameras (the right side in FIG. 1B), in the bottom part of the device. In one embodiment, a fourth image of this second set of images is taken by illuminating the entity with a fourth illumination group (reference D in FIG. 1B), for example the group on the first side of the cameras (the left side in FIG. 1B), in the bottom part of the device.

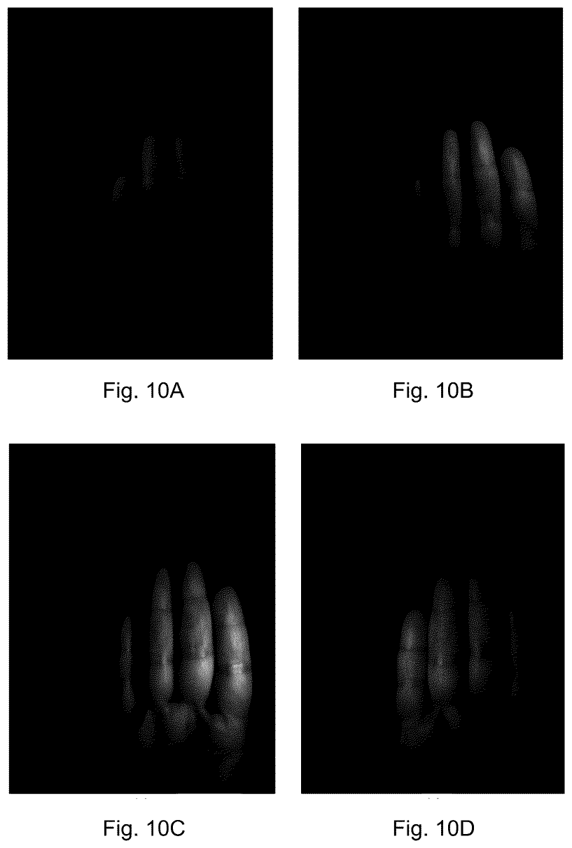

FIGS. 10A to 10D show a non-limitative example of those four images of the second set of images, which are used for PS.

In one preferred embodiment, a Stereo Vision (SV) reconstruction of the inspecting portion is also performed, by using two cameras at different angles and generally one light source (usually ambient light). The SV reconstruction allows to obtain overall depth and/or 3D relief of the inspection portion.

The SV reconstruction, combined with the PS reconstruction, allows to improve even more the device 100 accuracy.

In one embodiment, SV is done with data or images from two NIR cameras.

For SV 3D reconstruction it is important to have an accurate characterization of the relative position of the stereo camera pair (extrinsic parameters), as well as a per camera projection matrix and lens distortion coefficients (intrinsic parameters). In one embodiment, intrinsic camera parameters are approximated with a 5-parameter lens distortion model and a camera matrix, while extrinsic parameters are given by a 3D rotation matrix and translation vector relative to the left camera.

In one embodiment, the reconstruction of the 3D depth map is done from a pair of rectified, undistorted and aligned, left-right image pair. In particular, the are that the rectification parameters, intrinsic and extrinsic, 3D space appear at the same height in the image plane of

$$d = x - {x}^{′} = \frac{Bf}{z}$$

3D space appears at pixel positions x on the left image and x′ on the right image, the difference is called the disparity
(2)
where B is the baseline distance between the two cameras, f is the focal length and z is the distance of the 3D point to the image plane.

In order to find the disparity map, and depth map, a semi-global matching (SGM) algorithm is implemented. With the depth information it is possible to align the RGB image pixel-wise with the reference left rectified view.

The device 100 is therefore able to acquire images of an entity in several NIR wavelengths, for vascular features. If a colour camera is present, the device 100 is therefore able to acquire images in visible light (RGB), for surface features such as fingerprint and palmprint.

Depth information can be captured by using a pair of NIR cameras with laser pattern projectors and by varying the angle of incidence of the illumination source. This data can be combined to reconstruct the precise shape, texture and reflectivity map, throughout various wavelengths, of the target using Stereo Vision (SV) and Photometric Stereo (PS), yielding high quality data unavailable in the state of the art.

In other words, the device 100 allows to record hand vascular images in NIR wavelengths (e.g. 850 nm and 950 nm) and skin surface in colour (RGB). With a pair of NIR cameras and by varying illumination incidence angle, it is also possible to extract precise and detailed depth and surface-normal maps using SV and PS, respectively.

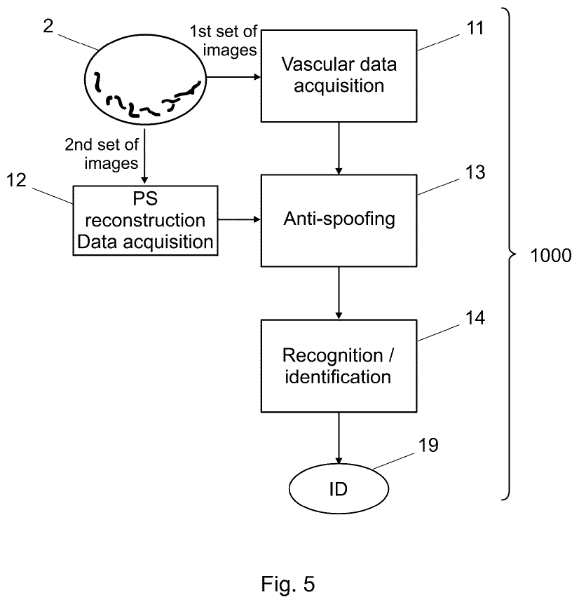

FIG. 5 shows an exemplary embodiment of a biometric vascular recognition and/or identification method 1 for recognizing and/or identifying a user based on his vascular biometric of at least one finger 2, a palm of the hand, a hand or a wrist of a user. It the following, we will refer to a finger for simplicity.

The biometric vascular method 1000 comprises:
a vascular data acquisition step 11, for acquiring a vascular biometric images or data of at least one finger 2;
a PS reconstruction data acquisition step 12, for acquiring images or data of the same finger 2, for PS reconstruction;
an anti-spoofing step 13 for deciding if the presented finger is a genuine body part or a spoof, based on the acquired vascular data and PS reconstruction data;
a recognition and/or identification step 14 for recognize and/or identify a user based on the acquired vascular data and PS reconstruction data, so as to provide an indication 19 about an ID/recognition of the user, when the presented entity is considered as a genuine body part (i.e. no spoof is detected).

In one embodiment, for performing FV authentication, FV samples are compared based on templates. To enroll a new user, the user first provides a biometric sample. A template, constructed from this sample, is stored in the device 100, associated with the user's identity. During the probe phase, the user claims a certain identity and provides a new biometric probe sample.

The device 100 then compares the probe-template, derived from the probe-sample, with the template previously enrolled for the claimed identity. If the two templates are sufficiently similar (i.e., the match-score is above a predetermined threshold), the claimed identity has been verified by the device 100.

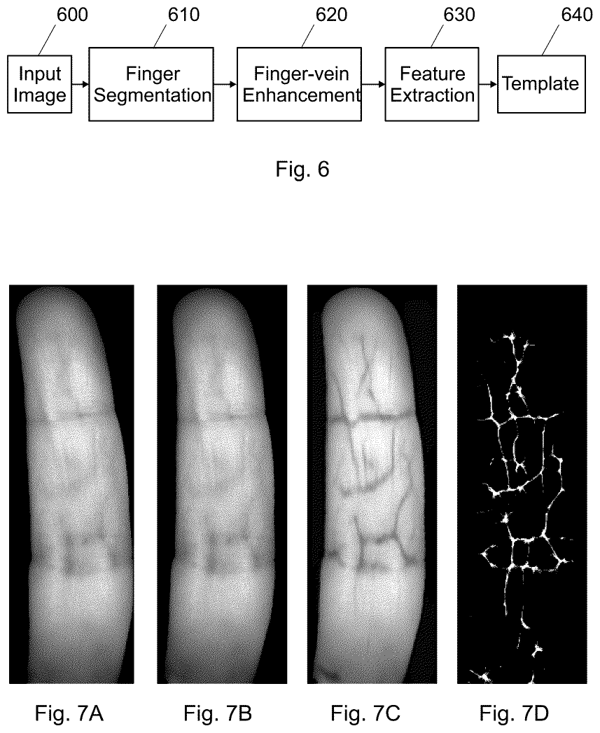

FIG. 6 shows a flowchart of the FV template creation process from a FV sample according to one embodiment of the invention.

In one embodiment, an input image is presented (step 600). In one embodiment, the input image corresponds to a presentation showing at least one finger of a presented hand. Preferably more fingers, e.g. three or four fingers (e.g. index-, middle-, ring- and little-finger) are presented. In case of more fingers, a template is constructed for each finger separately.

The finger(s) is(are) then segmented out from the input image (step 610). In one embodiment, a foreground mask using adaptive thresholding is generated to detect the hand-region (foreground object) in the image. Small regions in the resulting binary image can be deleted using morphological opening.

The foreground mask can then be scanned along the horizontal axis for the first foreground pixel (assumed to belong to the hand in the image). The detected pixel is assumed to correspond to the tip of one finger (the tallest finger). The left and right boundaries of the finger can be obtained by scanning horizontally for finger-edges on both sides. This scanning process is repeated for each row in the image, as long as the left and right finger-boundaries extracted correspond to a reasonable finger-width. The scanning process terminates when the estimated finger-width becomes too large at a certain row in the image. At this point it is assumed that all pixels representing a single finger have been identified. This finger is then removed from the binary image (set all finger-pixels to background) and the scanning process is repeated again, this time to find another finger. This procedure is repeated for up to n times, to detect the n fingers in the image.

In one embodiment, fingers are detected in order of their height in the input image (the finger closest to the top-edge of the image is detected first, followed by the second tallest, and so on).

In one embodiment, the relative coordinates of the center-of-gravity of each finger-mask is used to renumber the fingers in a natural order from index to little.

Next, a normalization step can be applied to each individual finger-image, for rotating the finger-image to align the longitudinal axis of the finger to the vertical axis as best as possible.

Next, a finger-vein enhancement step (step 620) is performed. In one embodiment, a pre-trained autoencoder is used to enhance the vascular structures in the input (normalized finger) image. The FV-enhancement improves the FV recognition accuracy significantly.

Next, a vascular feature extraction step (step 630) is performed. FV patterns are compared based on a set of image features extracted from the two vein-images being compared. In one embodiment, the Maximum-Curvature (MC) feature-map extracted for a single finger is considered as the biometric template for the finger. The finger-vein image can be scanned line by line in the direction transverse to the length of the finger. In each scan, the pixels of high local curvature (local second derivative of pixel values) along the line are marked as suitable feature-points. The MC feature-map extracted from an input FV-sample image is considered as the biometric template for the sample.

Next, a finger-vein matching step (step 640) is performed. In one embodiment, cross-correlation (e.g. computed in the frequency domain) is used to find the position of best match of the two-input feature-maps. In one embodiment, the cross-correlation coefficient at the best-match position is taken as the match-score between the two templates.

FIGS. 7A to 7D show an example result of the vein-enhancement (FIG. 7A: extracted finger image; FIG. 7B: normalized finger-image; FIG. 7C: vein-enhanced finger-image; FIG. 7D: MC-feature-map extracted from FIG. 7C). There is a slight rotation towards the vertical axis in FIG. 7B with regard to FIG. 7A. The normalized finger-image of FIG. 7B forms the input to the vein-enhancement autoencoder.

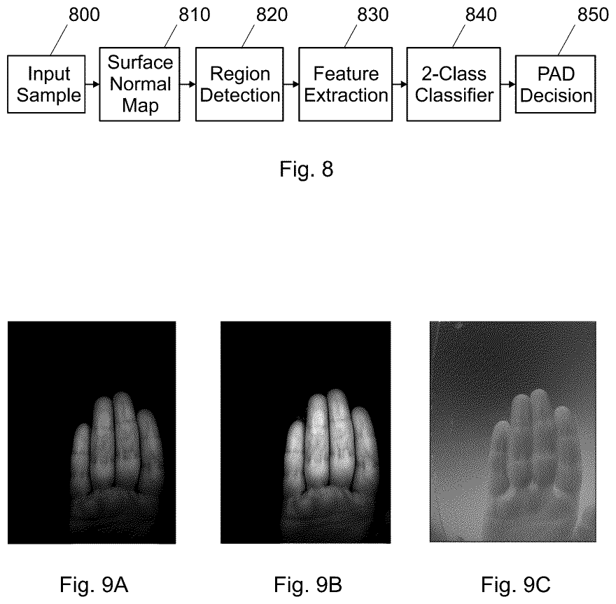

FIG. 8 shows a flowchart of b bb c according to one embodiment of the invention.

After providing an input sample (step 800), a surface-normal map is generated (step 810). In one embodiment, a surface-normal map is reconstructed for each NIR camera 30′, 30″. Each map comprises surface-normal vectors computed for each pixel-position.

The next step is the (finger- or palm- or hand- or wrist-) region detection step (step 820). K-means clustering can be used to group pixels into two clusters. The input to the clustering method comprises the three components of the surface-normal as well as the albedo value of each pixel. The cluster with the higher mean-albedo is considered as the foreground cluster. The largest foreground region is assumed to correspond to the presented entity. Connected-component analysis can be used to retain only the largest isolated region in the foreground cluster as the finger/hand-region.

The next step is the feature extraction step (step 830). Each surface-normal vector (x, y, z) of the retained region is transformed into an equivalent representation (θ1, θ2, M) where θ1 represents the angle of the vector with respect to the x-y plane and θ2 represents the angle of the vector with respect to the y-z plane. The angles θ1 and θ2 can be bounded a range, e.g. the range [−π/2, π/2]. In one embodiment, the magnitude, M, of the surface-normal vector is ignored. For each surface-normal map, a two-dimensional (2D) histogram can be constructed by quantizing θ1 and θ2 into Q bins each, over the detected hand-region (e.g. Q=41). These 2D histograms can be used to construct feature-vectors to distinguish between bona fide and PA classes. For both classes, a large majority of the histogram-bins are empty (bin count=0). Such empty bins act as confounders during the classification process. To mitigate this problem, the dimensionality of the feature-vectors is reduced, e.g. by using Principal Components Analysis (PCA).

The next step is the feature classifier step (step 840). In one embodiment, Gaussian Mixture Models (GMM) is used to classify the feature-vectors generated in the previous step 830. One GMM can be trained for each class (bona fide, PA). Given an input probe feature-vector, the likelihood that it comes from each of the two classes can be evaluated using the GMMs corresponding to each class. Specifically, for a given feature-vector, let ll_{BF} and ll_{PA} be the log-likelihood values returned by the GMMs for the bona fide and PA classes, respectively. In one embodiment, the difference (ll_{BF}−ll_{PA}) is taken as the classification-score for the probe feature-vector.

The next step is the PAD decision step (step 850).

FIGS. 9A to 9C shows finger-vein data captured in various channels using the device according to one embodiment of the invention (FIG. 9A: fingers illuminated under 850 nm; FIG. 9B: fingers illuminated under 950 nm; FIG. 9C: pseudo-colour map showing the 3D surface-normals reconstructed from the photometric stereo (PS) data).

Unlike existing FV devices that capture vascular data from only one finger at a time, the device according to the invention can image many (e.g. four) fingers of a hand simultaneously. This enables to implement contactless multi-finger vein recognition, which is not possible using known FV devices.

Each finger of a user is treated as a unique identity. A probe-sample is compared to an enrolled reference based on maximum-curvature (MC) vein features. Finger-veins can be enhanced using an autoencoder based method.

Score-fusion can be used to combine information from multiple fingers, to identify a hand. In the score-fusion, each hand is considered as a unique identity, represented by a number of fingers, e.g. three fingers. The FV Recognition (FVR) scores for the three fingers the hand are used to construct a feature-vector representing the hand. A two-class support vector machine (SVM) classifier is then trained to verify the identity of the presented hand.

Different protocols can be used, each protocol being composed of three items: <Modality> <Camera> <NIR wavelength [in nm]>.

In one embodiment, the modality can be left hand (LH) and right hand (RH). The camera can be a left camera (left) or a right camera (right).

In one embodiment, eight protocols are available:

TABLE 1

| Id. | Protocol Name |
|---|---|
| P1 | LH_left_850 |
| P2 | LH_left_950 |
| P3 | LH_right_850 |
| P4 | LH_right_950 |
| P5 | RH_left_850 |
| P6 | RH_left_950 |
| P7 | RH_right_850 |
| P8 | RH_right_950 |

Fusing the score of each protocol (same hand, same camera, same wavelength), a hand-recognition error rate of 0.06% can be achieved (a 10-fold improvement over the error-rate of recognition based on only one finger).

### REFERENCE SIGNS USED IN THE FIGURES

1 Hand
2 Finger
10 Top surface
11 Vascular data acquisition step
12 PS reconstruction data acquisition step
13 Anti-spoofing step
14 Recognition and/or identification step
19 ID/recognition step
20 Colour camera
30′ NIR camera
30″ NIR camera
40 Illumination bank
50 Base surface
60 Lateral surface
100 Device
200 Capture area of the camera 20
300′ Capture area of the camera 30′
300″ Capture area of the camera 30″
600 Input image step
610 Finger segmentation step
620 Finger-vein enhancement step
630 Feature extraction step
640 Template step
800 Input sample step
810 Surface-normal map step
820 Region-detection step
830 Feature extraction step
840 2-class classifier step
850 PAD decision step
1000 Method
α Tilting angle
A First PS illumination group
B Second PS illumination group
C Third PS illumination group
D Fourth PS illumination group

1. Contactless entity vein recognition and/or identification method, comprising:
presenting an entity to an entity vein recognition and/or identification device, wherein the interaction between the entity and the device occurs contactlessly, wherein the entity is at least one finger, a hand's palm, a hand and/or of a wrist;
capturing a first set of images of supposed subcutaneous veins of an inspecting portion of the entity from at least one NIR camera;
capturing a second set of images of supposed subcutaneous veins of the inspecting from the NIR camera,
estimating a likelihood that said supposed subcutaneous veins correspond to solid veins of the inspecting portion by using the first set of images;
performing a photometric-stereo reconstruction of the inspecting portion by using the second set of images;
deciding, based on said likelihood and on the photometric-stereo reconstruction, whether the entity is a genuine body part or a spoof.

2. Contactless entity vein recognition and/or identification method according to claim 1, wherein performing photometric-stereo reconstruction comprises capturing the second set of images under a controlled illumination-sequence, wherein each image is illuminated from a different angle.

3. Contactless entity vein recognition and/or identification method according to claim 1, wherein the first set of images and the second set of images are each captured by two NIR cameras.

4. Contactless entity vein recognition and/or identification method according to claim 3, wherein the entity is illuminated at 850 nm and at 950 nm.

5. Contactless entity vein recognition and/or identification method according to claim 1, comprising capturing a third set of images by a colour camera with white illumination, and using also the third set of images for deciding whether the entity is a genuine body part or a spoof.

6. Contactless entity vein recognition and/or identification method according to claim 1, comprising performing a Stereo Vision reconstruction by using at least one NIR camera and a laser dot projector, for reconstructing the shape, texture and/or reflectivity map, throughout various wavelengths, of the entity.

7. Contactless entity vein recognition and/or identification method according to claim 1, comprising capturing vein-images of multiple fingers simultaneously and combining information from several fingers, to increase the recognition and/or identification accuracy.

8. Contactless entity vein recognition and/or identification method according to claim 1, comprising creating a FV template from a FV sample.

9. Contactless entity vein recognition and/or identification method according to claim 8, comprising:
presenting an input image;
segmenting the entity out from the input image,
applying a normalization step to each individual finger-image, for rotating the finger-image to align the longitudinal axis of the finger to the vertical axis as best as possible,
enhancing the vascular structures in the input normalized finger image,
extracting vascular feature(s),
performing a finger-vein matching step.

10. Contactless entity vein recognition and/or identification method according to claim 9, comprising using a pre-trained autoencoder to enhance the vascular structures in the input normalized finger image.

11. Contactless entity vein recognition and/or identification method according to claim 9, wherein extracting vascular feature(s) comprising using a Maximum-Curvature feature-map extracted for a single finger.

12. Contactless entity vein recognition and/or identification method according to claim 1, comprising a PAD method, the PAD method comprising:
providing an input sample;
generating a surface-normal map, wherein each map comprises surface-normal vectors computed for each pixel-position;
detecting entity's regions;
performing a feature extraction so as to generate feature-vectors;
classifying feature-vectors;
performing a PAD decision.

13. Contactless entity vein recognition and/or identification method according to claim 12, wherein Gaussian Mixture Models (GMM) is used to classify the feature-vectors.

14. Contactless finger vein recognition and/or identification device, comprising:
a top surface, wherein the interaction between the entity and the top surface occurs contactlessly, wherein the entity is at least one finger, a hand's palm, a hand and/or of a wrist;
at least one NIR camera for capturing a first set of images of supposed subcutaneous veins of an inspecting portion of the entity, and for capturing a second set of images of supposed subcutaneous veins of the inspecting from the NIR camera,
a first computing module for estimating a likelihood that said supposed subcutaneous veins correspond to solid veins of the inspecting portion by using the first set of images;
a second computing module for performing a photometric-stereo reconstruction of the inspecting portion by using the second set of images;
a third computing module for deciding, based on said likelihood and on the photometric-stereo reconstruction, whether the entity is a genuine body part or a spoof.

15. Contactless finger vein recognition and/or identification device of claim 14, comprising three cameras.

16. Contactless finger vein recognition and/or identification device of claim 15, wherein the three cameras comprise a colour camera, e.g. an RGB camera, and two NIR cameras.

17. Contactless finger vein recognition and/or identification device of claim 15, wherein the cameras are arranged in a substantially triangular shape.

18. Contactless finger vein recognition and/or identification device of claim 15, wherein each of the cameras has an orientation substantially perpendicular to the top surface.

19. Contactless finger vein recognition and/or identification device of claim 14, comprising N illumination banks of M modules, each module comprising R light-sources.

20. Contactless finger vein recognition and/or identification device of claim 20, the light-sources being LEDs.

21. Contactless finger vein recognition and/or identification device of claim 14, comprising at least one illumination bank on one side and at least one illumination bank on the opposite side relative to the central camera(s).

22. Contactless finger vein recognition and/or identification device of claim 21, wherein each illumination bank is tilted or can be tilted around an axis.

23. Contactless finger vein recognition and/or identification device of claim 14, comprising in its internal volume one or more computing modules, an optional adapter module between the computing module(s) and each camera, a controller module, connected to each camera, the light sources, laser divers(s), an image sensor as a CCD or CMOS sensor, comprising an array of photodiodes or other types of detectors working together to capture images, and/or possible MEMS mirror(s) with possible driver(s) as high-voltage (HV) driver(s).

24. Contactless finger vein recognition and/or identification device of claim 14, wherein the first, second and/or third computing module are the same computing module.

25. Contactless finger vein recognition and/or identification device of claim 14, wherein each of the first, second and/or third computing module is or comprises a machine-learning module.
